(19) United States
(12) Patent Application Publication
(10) Pub. No.: US 2007/0282770 A1
(43) Pub. Date: Dec. 6, 2007

(54) System and methods for filtering electronic communications

(75) Inventor: Thomas Choi, Orleans (CA)

Correspondence Address: NORTEL NETWORKS LIMITED, 3500 CARLING AVENUE, OTTAWA, ON, K2H 8E9, CA

(73) Assignee: Nortel Networks Limited

(21) Appl. No.: 11/433,940

(22) Filed: May 15, 2006

(51) Int. Cl. G06F 15/18

(52) U.S. Cl. 706/20

(57) ABSTRACT

A system and method is provided for filtering anomalous electronic communications, for example spam. In particular the method provides for detecting behavior data or behavioral characteristics of a source of the electronic communication, processing of the behavioral characteristic data to determine anomalous communications and filtering anomalous communications. Beneficially source behavior data comprises that of a sending host and its neighboring hosts. Preferably, by employing a machine learning algorithm, detection is based on knowledge obtained during a training period.

### FIELD OF INVENTION

The present invention relates to data filtering systems, and in particular, to a system and method for filtering electronic communications, such as spam.

### BACKGROUND

Data filtering systems are useful for preventing anomalous electronic communications from entering a network. Such anomalous electronic communications typically comprise malicious, offensive or annoying content, sometimes referred to as spam, and are transmitted via services such as e-mail, web and instant messaging. Traditionally, these filtering systems have relied upon a combination of content and network based filtering techniques to provide detection and filtering of anomalous communications while allowing other communications to be accepted.

Current content based filtering techniques include matching algorithms such as keyword or signature based matching as well statistical methods such as Bayesian filtering. A problem with today's content based filters is that attackers can easily modify the content of their electronic communications to pass through such filters. For example, attackers can get their anomalous electronic communications past current content matching filters by embedding their text within an image in their communication. Furthermore, attackers are also able to get their anomalous electronic communications past Bayesian filters by randomly inserting ‘clean’ words while at the same time minimizing the amount of ‘dirty’ words in the content of their communications. As such, filtering solutions that rely upon content-based rules are unable to effectively block anomalous electronic communications.

Current network based filtering techniques comprises of a set of lists which typically includes a blacklist and a whitelist. With a blacklist, any electronic communication coming from a listed source is to be filtered or labeled as suspicious, whereas, any electronic communication coming from a whitelisted source should be accepted. Such blacklists and whitelists are typically populated with information such as the source's domain name, Internet Protocol (IP) address or e-mail address. A problem with these lists is that they are populated on a detection-based approach. In other words, in order for a source to be listed in a particular blacklist, that source had to have demonstrated anomalous behavior at some point in time. With thousands of new malicious sources being generated everyday, such reactive based approaches are always a step behind the attacker. Another problem with network based filtering is that it is unclear as to how long a source should remain in either the blacklist or whitelist. This typically results in false positives or false negatives and is a serious problem if too many legitimate electronic communications get blocked or too many anomalous electronic communications pass through. As such, network based filtering techniques are reactive, and can result in major issues with regards to false positives or false negatives.

It is also well known in the art to develop a filter which combines the above mentioned techniques. For example, the SpamAssassin™ e-mail filtering software uses a combination of content filtering and networking based rules. Each rule has a corresponding score which is generated from a learning based algorithm such as a single perceptron neural network. When such software receives an e-mail, the e-mail is checked against the various content and network based rules. If a particular rule is met then the corresponding score is added to the overall score of the e-mail. Once all the rules have been applied, the overall score of the e-mail is compared against a threshold and if the e-mail score is below the threshold then the e-mail is accepted whereas, if the score is at or above the threshold then the e-mail is discarded. However, such combined approach fails to address above-mentioned problems introduced by each of the two methods.

Accordingly, there is a need for an improved system and method for filtering electronic communications such as spam.

### SUMMARY

The present invention seeks to obviate or mitigate at least one of the above mentioned problems.

According to one aspect of the present invention there is provided a method for filtering electronic communications comprising receiving electronic communications; retrieving behavior data associated with behavioral characteristics of a source of said electronic communication; processing said behavior data; detecting anomalous electronic communication based on processed behavior data; and filtering said anomalous electronic communication.

Thus filtering is based on data associated with the behavior or behavioral characteristics of a source of the electronic communication. Beneficially, filtering is based on behavior data from a source which comprises a sending host and its neighbors. Filtering based on source behavior data provides a novel approach to accepting or filtering of anomalous communications which may be used alone, or in combination with known contextual and network filtering for improved control of anomalous communications.

Such behavior data may be data, for example, representing the volume of electronic communications received from connecting IP address/range over a seven day period; volume of electronic communications blocked from connecting IP address/range over seven day period; total number of connections that the IP address/range made to a known trap; total number of user complaints from electronic communications received from clients; number of days that the IP address/range sent good electronic communications; number of days that the IP address/range sent anomalous electronic communications or similar information, which may be stored as Domain Name Server (DNS) records

According to another aspect of the present invention, there is provided a method for training a machine learning algorithm for detecting anomalous electronic communication comprising retrieving behavior data associated with behavioral characteristics of likely good and anomalous sources of electronic communications; and processing said good and said anomalous sources such that the machine learning algorithm can distinguish between said sources.

According to another aspect of the present invention, there is provided a system for filtering anomalous electronic communication comprising: a server for receiving electronic communication; and a server module electronically linked to said server for retrieving behavior data associated with a source of said electronic communication, and a processor for processing said behavior data to detect anomalous electronic communications, and filtering said communication.

According to another aspect of the present invention, there is provided a system for filtering anomalous electronic communications comprising: a server for receiving electronic communication; a server module for filtering anomalous electronic communications comprising: a data parsing engine for parsing content of electronic communication and behavior data comprising DNS records associated with a sending host and its neighbors; and a processor for implementing a machine learning algorithm using data parsed from said parsing engine to detect anomalous electronic communications; and a quarantine for storing filtered electronic communication.

Other aspects and features of the present invention will become apparent to those ordinarily skilled in the art upon review in conjunction with the accompanying figures.

### DESCRIPTION OF DRAWINGS

Embodiments of the present invention will now be described, by way of example only, with reference to the attached Figures, wherein:

FIG. 1 is a block diagram of a computer network including a sending host for sending a electronic communication to a client computer, according to an embodiment of the present invention;

FIG. 2 is a block diagram representing a machine learning algorithm of the server module electrically connected to the server according to an embodiment of the invention;

FIG. 3 is a flow chart representing a machine learning algorithm process in the training phase;

FIG. 4 is a flow chart representing a machine learning algorithm process in the usage phase.

### DETAILED DESCRIPTION

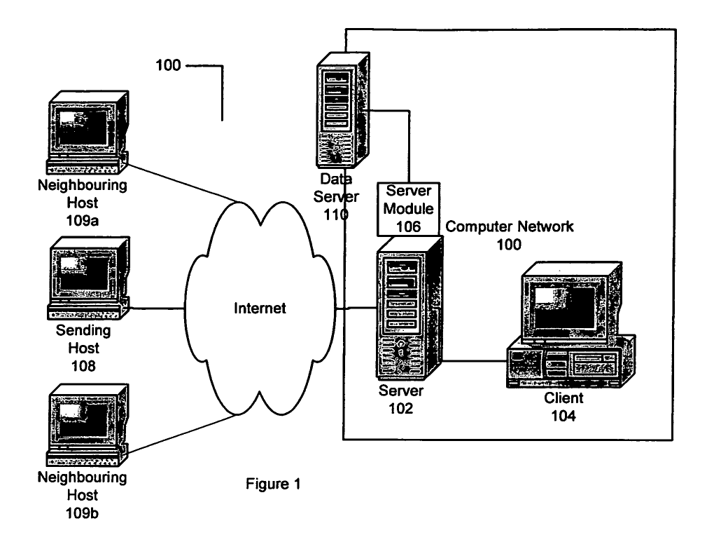

Referring to FIG. 1, a typical communications network context within which the invention is applicable includes a server computer 102 and client computer 104 connected through or forming part of a computer network 100. The server computer 102 may be, for example, a mail server, or a proxy server for web or instant messaging traffic. The computer network 100 may be, for example, a corporate or internet service providing network. Outside of the network, there exists a sending host 108 in communication with the client computer 104 via server computer 102.

The server computer 102 is electronically linked to a server module 106 that determines whether to accept or filter certain electronic communications from the sending host 108. The server module 106 makes its decision by analyzing data stored on a data server 110 as well as analyzing the content the electronic communication that the sending host 108 is trying to deliver.

The data server 110 provides the server module 106 with a set of data—referred to as “behavior data” that describes the behavior or behavioral characteristics of a source of the electronic communication, wherein the source comprises the sending host 108 and its neighboring hosts e.g. 109a and 109b, and others (not shown). The benefit of analyzing the behavior of neighboring hosts is that malicious content may typically originate from machines infected with a computer worm. Since computer worms are known to propagate via network means, chances are that if an infected machine is spewing malicious content, its neighboring hosts are also infected and spewing malicious content as well.

In one embodiment of the present invention, the behavior data associated with the source is obtained and stored in the data server 110 as a set of Domain Name Server (DNS) TXT records. The server module 106 retrieves the DNS TXT records of the sending host, its class C network and class B network. A sample of such TXT records are shown below:
10.32.3.4 IN TXT “1 2 3 4 5 6” sending host's behavioral data
10.32.3.* IN TXT “1 2 3 4 5 6” sending host's class C network behavioral data
10.32.*.* IN TXT “1 2 3 4 5 6” sending host's class B network behavioral data
where:
1=total volume of electronic communications received from connecting IP address/range over a seven day period.
2=total volume of electronic communications blocked from connecting IP address/range over seven day period.
3=total number of connections that the IP address/range made to a known trap.
4=total number of user complaints from electronic communications received from clients.
5=total number of days that the IP address/range sent good electronic communications.
6=total number of days that the IP address/range sent anomalous electronic communications.

In the above example, the first record is the sending machine's TXT record, the second record is the connecting IP address's class C TXT record and the third record is the connecting IP address's class B TXT record. Each record has six fields which are parsed by the server module's 106 parsing engine and the resulting parsed inputs 202 are applied to the input of the server module's machine learning algorithm 206.

It should be noted that behavioral data can be represented by any number of fields and that any number or combination of records can be used. In other words, the present invention is not limited to DNS TXT records, the six inputs or the IP address ranges listed in the example above. In alternative embodiments, other suitable sets of behavior data may alternatively be used for any range of IP addresses in any DNS record format. For example, the rbldns format could be used to provide behavioral insight on the IP address range of 1.2.3.4 to 1.2.3.100 by indicting the number machines in the IP range that are listed in various trusted third party blacklists such as the CBL and SBL.

The server module 106 may also perform a content rule analysis 204 which compares the content of the electronic communication from the sending host 108 against a set of content-based rules. The results from the content rule analysis 204 provides further insight with regards to the behavior of the source, and such behavioral characteristic data 204 is also applied to the input of the machine learning algorithm.

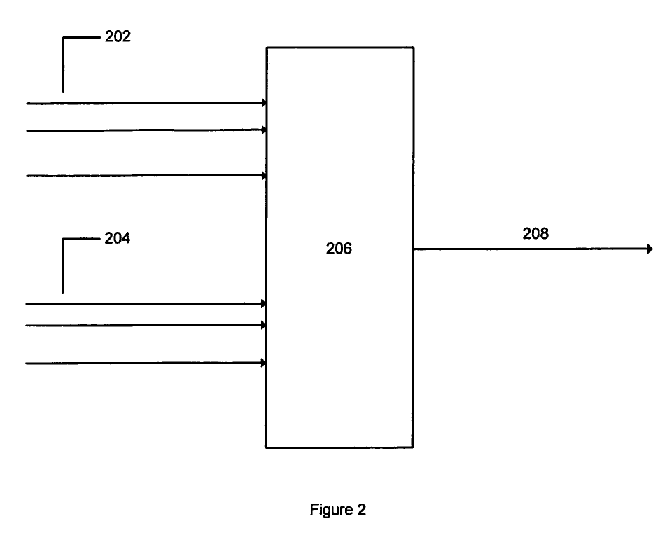

Referring to FIG. 2, the behavior data in the form of parsed inputs 202 from the data server 110 and the behavior data from the content rule analysis 204 are applied to the inputs of a machine learning algorithm 206. This machine learning algorithm 206 may be, for example, a neural network or fuzzy system. In a neural network, each of the inputs are assigned a pre-determined weight which is calculated during a training phase of the algorithm such that when a behavioral input value is applied to an input of a neuron, the value is multiplied by the input's corresponding pre-determined weight. The neuron then computes the sum of all these computations and applies the sum to a sigmoid function to determine an output value.

In a fuzzy system, the inputs are tested against a set of conditional rules which are also generated during a training phase of the algorithm. In a neural-fuzzy system, the inputs are assigned a pre-determined weight and are also tested against a set of conditional rules. The neuro-fuzzy network design is similar to that of the neural network with the key difference being the mathematical computations used. Specifically, instead of multiplying the input and the weight, the values are ORed instead. As well, instead of applying the sigmoid function to determine the output value, an AND function is used instead. It should also be mentioned that other machine learning algorithms may also be used. Regardless as to which machine learning algorithm is used, the algorithm 206 processes the inputs 202, 204 and generates an output 208 which indicates whether an anomalous electronic communication was detected.

The algorithm 206 has two phases of operation. The first phase is the training phase where it is taught how to differentiate between good electronic communications which may be accepted and anomalous electronic communications which are to be filtered. Once the training phase is complete, the algorithm 206 enters a usage phase where it is able to make its own decisions based on the knowledge it obtained in the training phase.

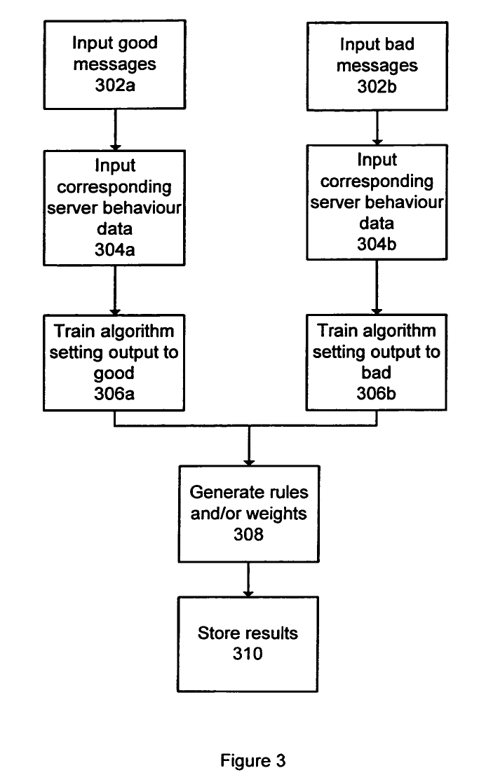

Referring to FIG. 3, the training phase of the machine learning algorithm begins by training the algorithm with a corpus of both good 302a and anomalous electronic communications 302b along with the behavior records that describe their corresponding sources 304a 304b. To minimize the number of false positives, the machine learning algorithm is trained using a large corpus of data from likely sources of electronic communications. For example, a medium sized North American company that only deals with customers in one of two official languages could train the machine learning algorithm using electronic communications from network sources associated only with those languages. If appropriate, training may be limited to English network sources only.

When training the ‘good’ records, the expected output of the learning algorithm is set to a value such as ‘1’ to represent ‘good’ communication 306a and when training the ‘anomalous’ records, the expected output of the learning algorithm will be set to a value such as ‘0’ to represent ‘anomalous’ 306b communication. The training iterates through the entire corpus of data and stops once a specified number of iterations is reached or when the corresponding error value is below a pre-set error threshold. Once training is completed, the weights for each input or conditional rule is then generated 308 and stored in a configuration file for future use 310.

For example, in the neural network design, an incremental delta-error rule could be used to train the weight values of the input. As previously mentioned, for each set of inputs, there is an expected output value as well as an actual output value. An error value is computed for each set of inputs by comparing its actual output value with the expected output value. Specifically, the error between these two output values is computed using the following equation:
E(w)=(½)Σₑ(yₑ−oₑ)²

where:

yₑ is the expected output, oₑ is the actual output generated by the learning algorithm,

If this error value is above the pre-set error threshold then the algorithm must adjust the weights. The weight adjustment value is computed via the following error delta equation:
Δwᵢ=Δwᵢ+η(yₑ−oₑ)σ(s)(1−σ(s))xᵢₑ

where:
σ(s)=1/(1+e^{-s}), where: s=Σᵢ₌₀^{d}wᵢxᵢ

yₑ is the expected output, oₑ is the actual output generated by the learning algorithm,

wᵢ is the weight associated with the i-th connection.

Once the error delta value is calculated, the weights for each input are subsequently adjusted via the following equation:
wᵢ=wᵢ+Δwᵢ

After the weights are adjusted, the next set of inputs are applied to the input of the learning algorithm and the corresponding actual output value is computed. If the error of this output, relative to the expected output, is above the pre-set error threshold then the weights are adjusted again. This process continues for the entire corpus until the error is below threshold for all sets of inputs.

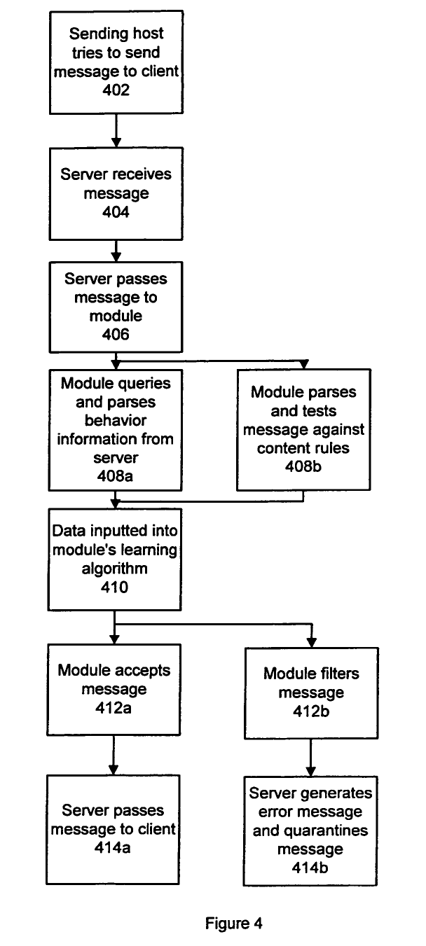

Referring to FIG. 4, the usage phase of the machine learning algorithm 406 begins when the sending host tries to send an electronic communication to the client 402. Such communication is typically relayed through the server, which upon receipt, provides the electronic communication to the server module 406. The server module then retrieves and parses relevant behavior data describing the sources 408a of said electronic communication. The server module also parses the content of the electronic communication to test the electronic communication against given content rules 408b. The behavioral information and rule results are provided as inputs to the module's machine learning algorithm 410 to generate a score which indicate whether the electronic communication is to be accepted 412a or filtered 412b.

In one embodiment of the present invention, the output of the algorithm is limited to a range between 1 and 0 where a ‘1’ represents a good electronic communication and a ‘0’ represents an anomalous electronic communication. In this model, an acceptance threshold is set to determine whether an intermediate value between 1 and 0 should be filtered or not. Specifically, if an output value is at or above the acceptance threshold then the electronic communication is filtered whereas if the value is below the acceptance threshold level then the electronic communication is accepted. If the electronic communication is to be accepted, then the electronic communication is forwarded to the client 414a. If the electronic communication is to be filtered, then the sending host is provided with an inline error response which includes instructions on what to do if the electronic communication was filtered in error. Such filtered electronic communications are subsequently quarantined for future retrieval and are not passed to the client 414b.

In an alternate embodiment of the usage phase, the module 106 asks the data server 110 if the sending host 108 is trusted by determining if the host is listed in a whitelist. If the sending host is listed, then the server 102 immediately accepts the electronic communication. If the sending host is not in the whitelist then the module 106 follows the usage phase described above and filters the anomalous electronic communication.

The present invention is able to overcome the problems of known solutions by utilizing data describing the behavior of the sending host and its neighbors. Analysis of the content of the electronic communication provides the additional benefits of existing content filtering techniques. Thus the method and system described above may be used independently, or in combination with known content and network filtering methods, to improve filtering of anomalous communications.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for filtering electronic communications comprising:
receiving an electronic communication;
retrieving behavior data associated with behavioral characteristics of a source of said electronic communication;
processing said behavior data;
detecting anomalous electronic communication based on processed behavior data; and
filtering said anomalous electronic communication.

2. A method according to claim 1, wherein said behavior data describes the behavior of a source of said electronic communication comprising a sending host.

3. A method according to claim 1, wherein said behavior data describes the behavior of a source of said electronic communication comprising a sending host and its neighboring hosts.

4. A method according to claim 3, wherein said behavior data comprises Domain Name Server (DNS) records associated with said sending host and neighboring hosts.

5. A method according to claim 1, further comprising comparing the content of said electronic communications against a set of content-based rules, and processing output of content rule analysis in addition to said behavior data to detect anomalous electronic communication.

6. A method according to claim 1, wherein the step of processing is performed by a machine learning algorithm and the step of detecting comprises using knowledge obtained during a training period.

7. A method according to claim 1, further comprising the step of storing the filtered electronic communication in a quarantine for future retrieval.

8. A method according to claim 1, further comprising the step of generating an error response with instructions on what to do if the electronic communication was filtered in error.

9. A method according to claim 1, further comprising the step determining if a source is trusted, and performing the step of filtering the anomalous communication only if the source is not trusted.

10. A method for training a machine learning algorithm for detecting anomalous electronic communication comprising:
retrieving behavior data associated with behavioral characteristics of likely good and anomalous sources of electronic communications; and
processing said behavior data from said good and anomalous sources such that the machine learning algorithm can distinguish between said sources.

11. A method according to claim 10, further comprises comparing the content of said electronic communications against a set of content-based rules and processing output of the content rule analysis with said behavior data for identifying anomalous electronic communication.

12. A system for filtering anomalous electronic communication comprising:
a server for receiving electronic communication; and
a server module linked to said server for retrieving behavior data associated with a source of said electronic communication and processing said behavior data to detect anomalous electronic communications and filtering said communication.

13. A system according to claim 12, wherein the server module comprises a data parsing engine that parses DNS records to retrieve said behavior data.

14. A system for filtering anomalous electronic communications comprising:
a server for receiving electronic communication;
a server module for filtering anomalous electronic communications comprising:
a data parsing engine for parsing content of electronic communication and behavior data comprising DNS records associated with a sending host and its neighbors; and
a processor implementing a machine learning algorithm using data parsed from said parsing engine to detect anomalous electronic communications; and
a quarantine for storing filtered electronic communication.
